(19) United States
(12) Patent Application Publication
(10) Pub. No.: US 2015/0165351 A1
(43) Pub. Date: Jun. 18, 2015

(54) PLEATED FILTER WITH MOLDED END CAP

(71) Applicant: BHA Altair, LLC, Franklin, TN (US)

(72) Inventors: Alfred Lo, Lee's Summit, MO (US); Jeff Allen Canfield, Belton, MO (US)

(21) Appl. No.: 14/105,626

(22) Filed: Dec. 13, 2013

(51) Int. Cl. B01D 29/13; B01D 29/11

(52) U.S. Cl. CPC B01D 29/13; B01D 29/111

(57) ABSTRACT

A filter includes a pleated filter material with a plurality of pleats arranged circumferentially in a first star-shaped pattern. An end cap is coupled with an axial end of the pleated filter material. The end cap includes a central core portion and a plurality of radiant tips extending from the central core portion in a second star-shaped pattern corresponding to the first star-shaped pattern.

### BACKGROUND OF THE INVENTION

The invention relates to a pleated filter and, more particularly, to a pleated filter including a molded end cap that conforms to the pleated shape of the filter media.

Traditional end cap molding forms an end cap 2 with a flat bottom (FIG. 1) that results in a flat bottom disk (FIG. 2). The traditional filter element is susceptible to dust particle accumulation in both static and pulsed applications on the flat ledge 4 between filter pleats. In certain applications, dust build-up on a pleated filter element is undesirable due to the potential for food/pharmaceutical contamination, or accumulation of combustible dust. Additionally, the typical end cap center portion can be damaged by puncturing or the like by the inside core element, which may be metal or plastic, during pulsing or pressure change across the filter during operation.

It would be desirable to provide a filter including an end cap without horizontal ledges where dust can accumulate and that is reinforced to improve the integrity of the end cap structure.

### BRIEF DESCRIPTION OF THE INVENTION

In an exemplary embodiment, a filter includes a pleated filter material with a plurality of pleats arranged circumferentially in a first star-shaped pattern, and an end cap coupled with an axial end of the pleated filter material. The end cap includes a central core portion and a plurality of radiant tips extending from the central core portion in a second star-shaped pattern corresponding to the first star-shaped pattern.

In another exemplary embodiment, a filter includes a pleated filter material with a plurality of pleats arranged circumferentially in a star-shaped pattern, and an end cap coupled with an axial end of the pleated filter material. The end cap includes a central core portion and a plurality of radiant tips extending from the central core portion in a corresponding star-shaped pattern. The central core portion has an axial thickness that is thicker than an axial thickness of the radiant tips.

In yet another exemplary embodiment, a method of making a filter includes the steps of circumferentially arranging a pleated filter material in a star-shaped pattern; molding an end cap including a central core portion and a plurality of radiant tips extending from the central core portion in a corresponding star-shaped pattern; and coupling the molded end cap with an axial end of the pleated filter material.

### BRIEF DESCRIPTION OF THE DRAWINGS

FIGS. 1 and 2 show the prior art filter design;

FIG. 3 is a perspective view of the filter according to preferred embodiments;

FIG. 4 is a bottom perspective view of the filter showing the end cap; and

FIG. 5 is a close-up view of the filter end cap.

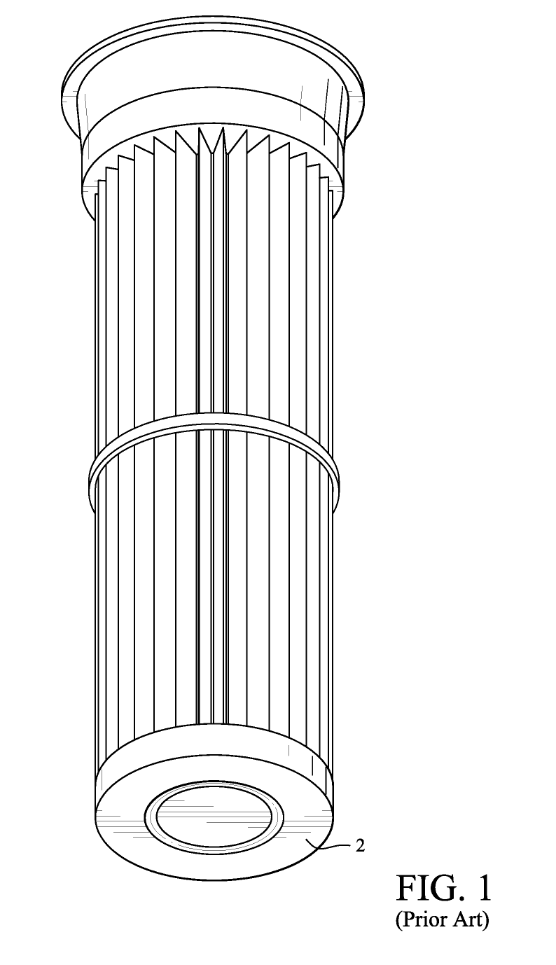

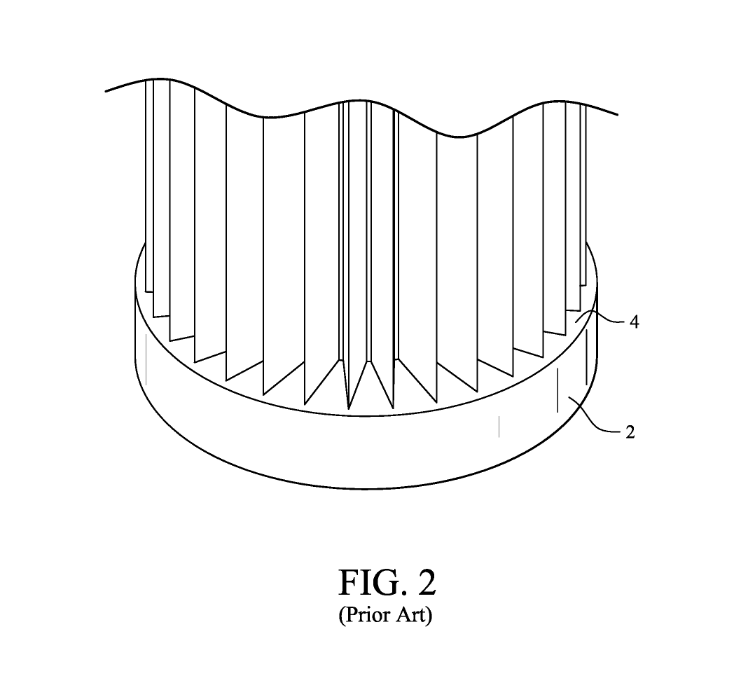

### DETAILED DESCRIPTION OF THE INVENTION

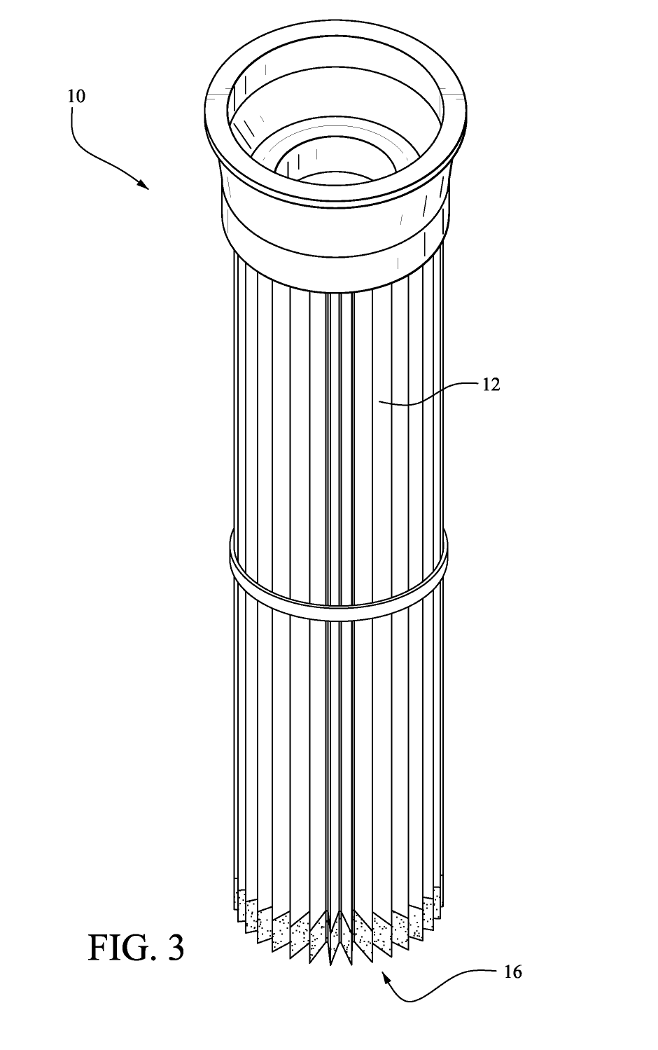

With reference to FIGS. 3-5, a filter 10 includes a pleated filter material 12 including a plurality of pleats 14 arranged circumferentially in a star-shaped pattern. An end cap 16 is coupled with an axial end of the pleated filter material 12. The end cap 16 includes a central core portion 18 and a plurality of radiant tips 20 extending from the central core portion 18 in a star-shaped pattern corresponding to the star-shaped pattern of the pleated filter material 12.

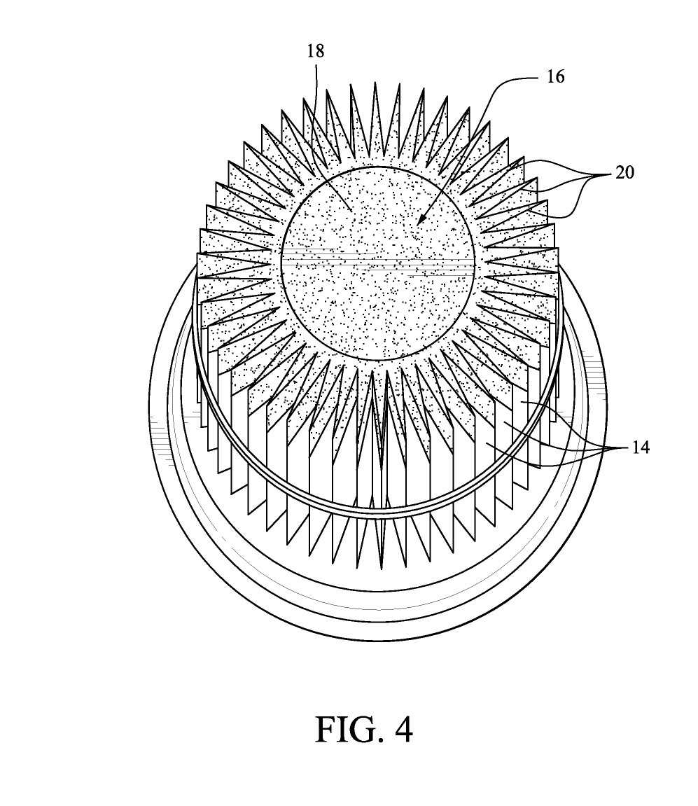

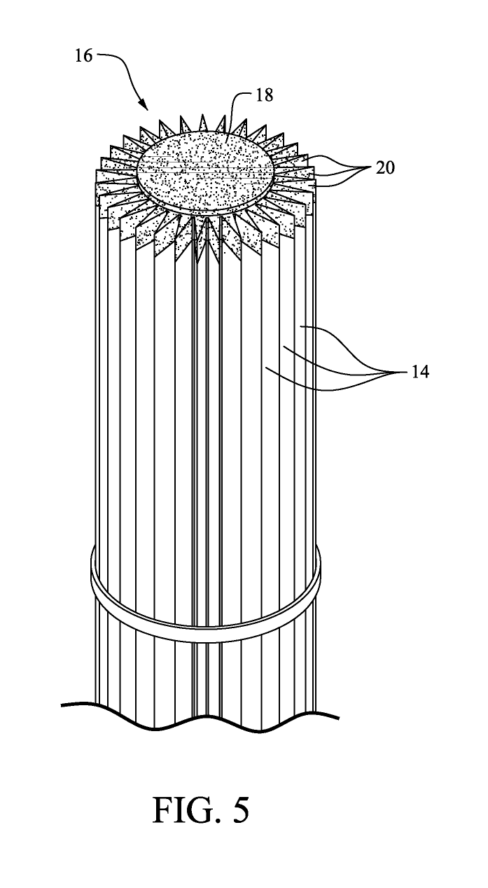

The circumferentially arranged pleats 14 define an inner diameter and an outer diameter. That is, the outer diameter is defined by the outermost peaks of the circumferentially arranged pleats 14, and the inner diameter is defined by the innermost valleys of the pleats 14. The central core portion 18 of the end cap 16 is disposed within the inner diameter, and the radiant tips 20 extend from the central core portion 16 to the outer diameter. In an exemplary construction, each pleat 14 is defined by a rise from the inner diameter to the outer diameter and a fall from the outer diameter to the inner diameter in a V-shape. As shown in FIGS. 4 and 5, the radiant tips 20 may extend only within the V-shape of the pleats 14.

As shown most clearly in FIG. 5, the central core portion 18 may be thicker axially than the radiant tips 20. Specifically, the central core portion 18 is at least 10-50% thicker than the radiant tips. As shown, the axial end of the pleated filter material 12 may be flush with the radiant tips 20, while the central core portion 18 defines a step due to its increased thickness. The central core portion 18 generally comprises a cylindrical puck that fills the inner diameter defined by the circumferentially arranged pleats 14.

In an alternative variation, the central core portion may be slightly larger in diameter than the inner diameter of the pleat tips. This arrangement serves to reinforce stress points at the inner diameter pleat tips. The central core portion in this embodiment may be up to 10% larger in diameter than the inner diameter of the pleat tips.

The end cap can be formed using any suitable process. In an exemplary process, the end cap is molded using a polymer material. One suitable polymer material is polyurethane. The molded end cap is coupled with the axial end of the pleated filter material during the molding process by embedding the axial end of the filter material during the molding step.

The filter incorporates a molded polymer end cap that conforms to the pleated shape of the filter media. Since horizontal extending ledges are thereby eliminated, problems associated with dust particle accumulation and the like can be avoided. Additionally, the thicker central core portion of the star-shaped end cap provides for reinforcement of the end cap structure so that the end cap can undertake higher impact forces acting onto it during use and/or cleaning. The thicker center portion minimizes potential for damage from the filter element core or pleat tips tearing or puncturing the polymer center cap.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A filter comprising:
a pleated filter material including a plurality of pleats arranged circumferentially in a first star-shaped pattern; and
an end cap coupled with an axial end of the pleated filter material, the end cap including a central core portion and a plurality of radiant tips extending from the central core portion in a second star-shaped pattern corresponding to the first star-shaped pattern.

2. A filter according to claim 1, wherein the circumferentially arranged pleats define an inner diameter and an outer diameter, wherein the central core portion is disposed within the inner diameter, and wherein the radiant tips extend from the central core portion to the outer diameter.

3. A filter according to claim 2, wherein the central core portion is thicker axially than the radiant tips.

4. A filter according to claim 3, wherein the central core portion is at least 10-50% thicker than the radiant tips.

5. A filter according to claim 3, wherein the axial end of the pleated filter material is flush with the radiant tips.

6. A filter according to claim 2, wherein each pleat is defined by a rise from the inner diameter to the outer diameter and a fall from outer diameter to the inner diameter in a v-shape, and wherein the radiant tips extend only within the v-shape of the pleats.

7. A filter according to claim 1, wherein the central core portion comprises a cylindrical puck that fills an inner diameter defined by the circumferentially arranged pleats.

8. A filter according to claim 7, wherein the central core portion is thicker than the radiant tips.

9. A filter according to claim 8, wherein the central core portion is at least 10-50% thicker than the radiant tips.

10. A filter according to claim 1, wherein the end cap is molded polyurethane.

11. A filter comprising:
a pleated filter material including a plurality of pleats arranged circumferentially in a star-shaped pattern; and
an end cap coupled with an axial end of the pleated filter material, the end cap including a central core portion and a plurality of radiant tips extending from the central core portion in a corresponding star-shaped pattern, wherein the central core portion comprises an axial thickness that is thicker than an axial thickness of the radiant tips.

12. A filter according to claim 11, wherein the circumferentially arranged pleats define an inner diameter and an outer diameter, wherein the central core portion is disposed within the inner diameter, and wherein the radiant tips extend from the central core portion to the outer diameter.

13. A filter according to claim 12, wherein each pleat is defined by a rise from the inner diameter to the outer diameter and a fall from outer diameter to the inner diameter in a v-shape, and wherein the radiant tips extend only within the v-shape of the pleats.

14. A filter according to claim 11, wherein the central core portion comprises a cylindrical puck that fills an inner diameter defined by the circumferentially arranged pleats.

15. A filter according to claim 14, wherein the central core portion is at least 10-50% thicker than the radiant tips.

16. A method of making a filter comprising:
circumferentially arranging a pleated filter material in a star-shaped pattern;
molding an end cap including a central core portion and a plurality of radiant tips extending from the central core portion in a corresponding star-shaped pattern; and
coupling the molded end cap with an axial end of the pleated filter material.

17. A method according to claim 16, wherein the molding step comprises molding the end cap with the central core portion having an axial thickness that is thicker than an axial thickness of the radiant tips.

18. A method according to claim 16, wherein the coupling step comprises embedding the axial end of the filter material during the molding step.
